(19) United States
(12) Patent Application Publication
(10) Pub. No.: US 2023/0167669 A1
(43) Pub. Date: Jun. 1, 2023

(54) WINDOW, MASONRY HAVING SUCH A WINDOW, AND CHARGING LAYOUT FOR CHARGING AN ENERGY ACCUMULATOR OF A MOTOR VEHICLE

(71) Applicant: AUDI AG, Ingolstadt (DE)

(72) Inventor: Andreas GALLASCH, Bietigheim-Bissingen (DE)

(21) Appl. No.: 18/060,496

(22) Filed: Nov. 30, 2022

(30) Foreign Application Priority Data
Dec. 1, 2021 (DE) 1020211315263

(51) Int. Cl. E06B 1/36; E06B 1/52

(52) U.S. Cl. CPC E06B 1/36; E06B 1/528

(57) ABSTRACT

A window includes a frame and a pivot frame arranged in the frame and hinge mounted on the frame, having a window pane, wherein at least one cable bushing to receive at least one cable is provided in the frame extending from one frame side to the opposite frame side.

### BACKGROUND

### Technical Field

Embodiments of the invention relate to a window, comprising a frame and a pivot frame arranged in the frame and hinge mounted on the frame, having a window pane.

### Description of the Related Art

The share of electrically operated motor vehicles is growing constantly and will also increase further in future. The energy accumulator of such a motor vehicle needs to be charged regularly. Besides charging stations installed in the public arena, charging options in private residences are also being increasingly provided, for example in garages of residential complexes, apartment buildings, row homes or separately standing homes. While the planning and integration of such charging stations for residential use in newly built houses is still relatively easy to do, the later installation of such a charging station in already finished buildings represents a major problem, since it usually requires an intervention in the building framework. As an example of such a charging station, one can mention a so-called “wallbox,” which requires an appropriately robust connection to the household power supply. In this case, especially in separately standing houses or row houses, the household connection and the current meter are usually provided in the basement level, i.e., in a cellar or a utility room, while the charging station or wallbox is to be mounted in a neighboring garage or a carport, since it must be close to the vehicle being charged. Now, in order to lay a cable connection from inside the building to the outside of the building, one usually needs to create a masonry breakthrough in such instances, through which the cable is led. This involves costly drilling labor, especially since the masonry often has a thickness of 30 cm or more. Furthermore, often the ground on the outside directly at the masonry breakthrough also needs to be removed. While a window which can be opened and through which the cable can essentially be led to the outside is often present in the cellar or utility room, the window then cannot be closed once more.

### BRIEF SUMMARY

Some embodiments indicate an option for a simplified, and in particular a retrofitted laying of a cable from the interior of a building to the outside.

In some embodiments a window is proposed, comprising a frame and a pivot frame arranged in the frame and hinge mounted on the frame, having a window pane, which window is characterized in that at least one cable bushing to receive at least one cable is provided in the frame extending from one frame side to the opposite frame side.

In some embodiments, a window is proposed which is already outfitted at the factory with a cable bushing in the frame and which is fixed in position in the masonry. The cable bushing, i.e., a corresponding opening or breakthrough, extends from the frame side at the inside of the masonry to the frame side at the outside of the masonry. Through this cable bushing or opening, a cable can be easily led from the inside to the outside without any costly drilling work or excavation work on the outside, while the cable can be any given kind of cable, such as an electrical cable for any given current strength or a communication cable (Telephone, Internet, TV), or a fuel line for gas, oil, wood pellets or the like, or a water conduit. Since a window is present in any case at the masonry, it is only necessary to replace this window with the window described herein in the case of already standing buildings, which can be done in a relatively simple manner. The new window then offers the lead-through capability described herein, but also the actual window functionality, since the new window has a corresponding window frame with glass pane. Furthermore, when the window is situated in a room below ground level, there is often a light shaft next to it on the outside, into which the cable is led out, and from which it can then be led further, without this requiring immediate excavation work on the outside of the masonry.

Besides the retrofitting of such a window in already standing buildings, the installation of the window described herein is also feasible in new structures, since such a window can be used either for conduits already being laid in the process of home building, or it affords the option of laying such conduits afterwards.

In particular, the window described herein is suitable for the retrofitted laying of an electrical cable for a retrofitted installation of a charging station such as a wallbox, which is presently being done in many places.

Although it is possible to provide only one cable bushing at the frame side, it is advisable to provide multiple separate cable bushings, so that multiple separate lead-through possibilities exist for a corresponding number of cables.

The multiple cable bushings can all have the same cross sectional area and cross sectional shape. But they can also differ in cross sectional area and/or cross sectional shape. That is, multiple round openings are provided, for example, yet they have different diameters, or multiple openings are provided having different cross sectional shapes, such as round, square, rectangular, etc. This makes it possible to adapt to different cable cross sections or to lead a cable through a cable bushing which is best adapted in terms of cross section. Furthermore, after the cable is installed the corresponding cable bushing also needs to be closed or sealed once more. The better the cross section of the cable bushing is adapted to the particular cross section, the smaller the space which needs to be closed or sealed afterwards.

It is advisable for the cable bushing or each cable bushing to be closed with a removable closure element. That is, the one or more cable bushings are provided at the factory, and they are also closed with a corresponding removable closure element at the factory. Thus, the respective closure element is only removed from the cable bushing, i.e., the corresponding breakthrough or borehole, when necessary, for example it is forced out by a corresponding strong pressure, so that the cable bushing is opened. This makes it possible to design the frame in the best possible manner in regard to thermal conduction thanks to the closure element or each closure element, since the closure elements can be chosen such that there is no significant change in the heat transfer coefficient across the surface of the frame. A cable bushing will be opened only when it is needed; until that time, the frame simply presents a closed structural piece. Such a conduit breakthrough can be opened not only to lead through a cable, but also to enable a room ventilation if necessary, since an unhindered exchange of air from the outside to the inside and vice versa is possible through an open cable bushing.

As described, the closure element or each closure element can be designed such that its heat transfer coefficient corresponds substantially to the heat transfer coefficient of the frame. A tolerance in regard to the heat transfer coefficients of +/−20%, or +/−10%, is feasible and easily tolerated. At the same time, the closure element will also be selected or installed such that it prevents the incursion of moisture or water, and therefore it seals off the cable bushing entirely in liquid-tight manner.

As described, the frame is anchored in fixed position with regard to the masonry, while the swivel wing can pivot relative to the frame anchored in fixed position. In this case, the frame can be outfitted for direct mounting in a soffit of a masonry, which soffit defines or borders the corresponding window opening. The frame is thus anchored directly in the masonry. In the case of a retrofitting in an already existing building, the already installed window should be removed, that is, the frame anchored at the masonry side should be loosened there, while the frame of the new window should be anchored in turn in the masonry. In the case of a new construction, the removal of the old window is omitted.

Alternatively, it is conceivable in the case of an already existing building to install the new window as it were in the frame of the old window, anchored at the masonry side, i.e., to remove the swivel wing of the old window and to install in its place the new frame with swivel wing in the existing frame. For this purpose, the frame of the window described herein can have at least two hinge elements on one frame side and on the other frame side it has at least one locking element, the hinge elements being adapted to connect with hinge elements of an existing frame on the masonry side and the locking element for locking to the frame on the masonry side. The swivel wing of the existing frame is hinge-mounted through corresponding hinge fittings on the frame incorporated in the masonry. After removing the swing wing, the frame of the window described herein now sits on the existing hinge fittings and existing frame, corresponding hinge elements being provided on the new frame, which are connected to the hinge elements on the existing frame. Thus, a kind of swivel connection will be produced here. Since the new window should not be able to swivel in the old frame, the frame of the new window has a locking element on the side opposite the hinge elements, by which the frame can be locked to the existing frame. This can be, for example, a bolt operated by a key, engaging with a corresponding lock receptacle on the existing frame, or the like. This lock naturally prevents a corresponding swiveling of the new window in the existing frame. The advantage of this variant is that no significant modification of the existing building framework is required, since the old frame is not torn out from its anchoring at the masonry side, but rather serves as a mounting interface for the new window.

Some embodiments relate to a masonry, comprising a window opening, in which a window of the kind described above is installed, wherein a cable is led from one side of the masonry to the other side of the masonry through a cable bushing provided in the frame of the window. This masonry is a corresponding wall of a building or construction, and the building or construction can be any given construction.

The frame of the window according to a first alternative can be installed directly in a soffit bordering on the window opening. Alternatively, the frame of the window can also be installed in a base frame installed in the window opening, being part of a window already originally present, and fastened to it, which can be done for example with the hinge elements and the locking element present on the new frame, as described above.

Moreover, a closure means closing the cable bushing can be provided on or in the cable bushing through which the cable runs. After leading the cable through the cable bushing, the latter must be appropriately closed and sealed once more. A corresponding closure means is used for this, being mounted in some embodiments on the outside of the masonry, when it is mounted on the frame on the outside, or being introduced finally into the cable bushing. That is, it is molded or cast, and alternatively or additionally a corresponding closure means can also be provided at the inside of the frame. Such a closure means can be, for example, a sealing cap, a sealing plug, or the like. The closure means may be chosen such that the heat transfer coefficient in the area of the closure means corresponds substantially to the heat transfer coefficient of the frame. That is, an effort is made also in regard to this closure means to not create any cold bridge if possible, but instead to ensure once more conditions in the area of the breakthrough, despite its opening, which correspond to the heat transfer conditions in the rest of the frame region. The cable running through it produces a corresponding change in the thermal conductivity, since the cable naturally conducts heat differently from the frame itself, but an effort can be made with the closure means used to seal off and insulate as best possible the otherwise still open cable bushing.

Furthermore, the closure means can serve as a tension relief for the cable. That is, the closure means, such as a closure cap or the like, is anchored in suitable manner on the cable, so that any tensile stress on the cable is absorbed by the closure means.

Some embodiments relate to a charging layout for the charging of an energy accumulator of a motor vehicle, having a charging device situated outside a building for the removable connecting to a charging terminal of the motor vehicle, at least one cable running from the inside of the building to the charging device, and a masonry as described above and provided at the building side, comprising a window as described above, wherein the cable is led through a cable bushing of the frame of the window. The charging device is either a charging station or a wallbox or the like.

### BRIEF DESCRIPTION OF THE SEVERAL VIEWS OF THE DRAWINGS

Further benefits and details will emerge from the following described embodiments, as well as the drawings.

FIG. 1 shows a schematic representation of a charging layout, comprising a masonry and a window.

FIG. 2 shows an enlarged partial view of the layout of FIG. 1.

FIG. 3 shows a more detailed view of masonry with an installed window of a first embodiment.

FIG. 4 shows a more detailed view of masonry with an installed window of a second embodiment.

### DETAILED DESCRIPTION

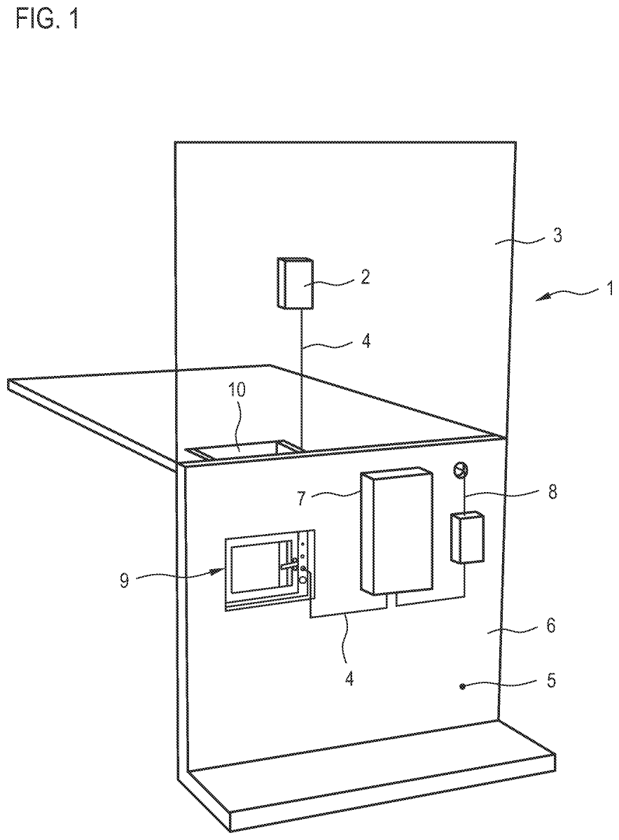

FIG. 1 shows a schematic representation of a charging layout 1 as described herein, serving to charge an energy accumulator of a motor vehicle. This comprises a charging device 2, here, a wallbox, which is located on a building wall 3, shown here as transparent for purposes of the drawing. A cable 4 runs to the charging device 2, coming from the interior of a cellar 5 of a building, only suggested, and being led to the outside. An electrical distribution or circuit box 7 is arranged on a masonry 6, in which a household conduit 8 runs, being supplied from the outside. The cable 4 runs from the circuit box 7 to a window 9, through the frame of which it is led. For this, multiple cable bushings are provided on the frame, as will be further explained below. On the outside, the window 9 is adjoined by a light shaft 10, through which the cable 4 in the example shown runs directly to the charging device 2. The cable 4 is a power cable, which is designed for a voltage of 380 V, for example.

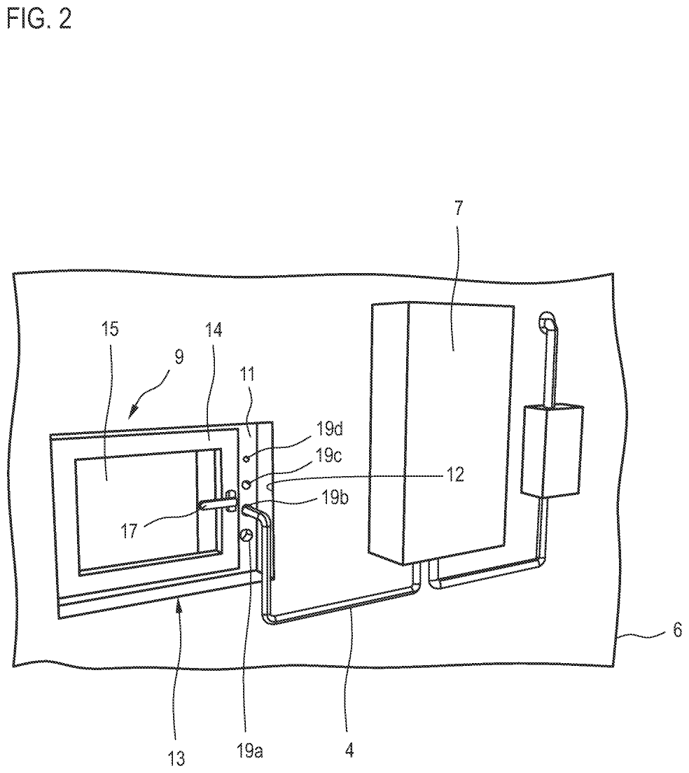

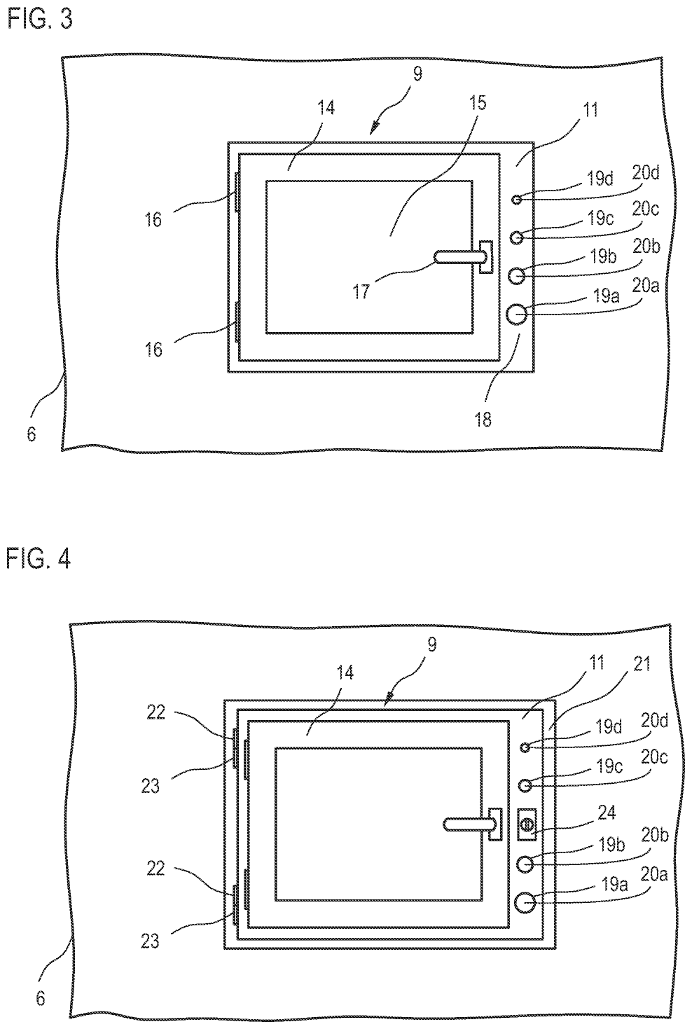

FIG. 2 shows in an enlarged view the masonry 6 plus the circuit box 7 and the window 9. The window 9, for which also see FIG. 3, comprises a frame 11, which in the example shown is designed to be installed or anchored directly in a soffit 12, which bounds a window opening 13 in the masonry 6. In the frame 11 there is swivel-mounted in known manner a pivot frame 14 having a window pane 15 by means of corresponding hinge elements 16. The window can be locked in the locked position or unlocked and opened through a window handle 17 with associated locking element.

The frame 11 has a somewhat broadened frame leg 18, shown at the right in the example, on which multiple cable bushings, in the example four separate cable bushings 19a, 19b, 19c, 19d, are provided. These cable bushings 19a, 19b, 19c, 19d are configured here as circular round boreholes, all of them having the same cross sectional shape, but differing in the cross sectional area. Thus, the cable bushing 19a has the largest diameter, which decreases in steps to the smallest diameter of the cable bushing 19d. Consequently, a cable 4 being led out from the building, and naturally also having a corresponding cross sectional area, can be led through the cable bushing 19a-d whose cross sectional area best corresponds to its cross sectional area.

This situation is shown in FIG. 2. Here, the cable 4 is led from the inside to the outside through the second largest cable bushing 19b, the cable bushings 19a-19d naturally running from the inner frame side to the outer frame side, so that the cable 4 can emerge on the outside of the masonry and run to the charging device 2.

In the configuration of FIG. 2, the unoccupied cable bushings 19a, 19c, 19d are shown opened. After laying the cable 4, it is necessary to close all open cable bushings 19a, 19c, 19d, as well as the occupied cable bushing 19b, once again with an appropriate closure means on the inside and outside or along the entire length. This may be done with appropriate closure plugs or closure caps or the like, or also with appropriate casting or caulking means introduced in the cable bushing 19a, 19b, 19c, 19d. Closure means may be used having the most comparable possible heat transfer coefficient to the frame 11 itself. The closure means by which the occupied cable bushing 19b is closed also has a tension relief, absorbing and compensating for any tensile stress acting on the cable 4.

Besides closing the cable bushings 19a, 19b, 19c, 19d, it is also conceivable to deliberately leave open one or another cable bushing in order to make possible a constant ventilation of the room through the open cable bushing.

FIG. 2 shows a window 9 in which the cable bushings 19a, 19b, 19c, 19d are open at the factory, and thus not closed. The individual bushing closure is done only after the installing of the window 9. On the contrary, FIG. 3 shows basically the same window 9, but in which the cable bushings 19a, 19b, 19c, 19d are closed at the factory by corresponding closure elements 20a, 20b, 20c, 20d. These closure elements 20a, 20b, 20c, 20d can be closure plugs, for example, which either reach through the entire frame or are installed in the frame 11 at the outside and inside and are finally flush with the inner and outer frame surface. That is, the frame 11 is closed and sealed at the factory. After the installation of the window 9, it is only necessary to remove the closure element or elements 20a, 20b, 20c, 20d of those cable bushings 19a, 19b, 19c, 19d, through which a cable 4 will afterwards be led, for example by axial pressing or pulling out from the corresponding cable bushing 19a, 19b, 19c, 19d. Consequently, this variant allows steps to be taken at the factory so that the frame 11 is tight and optimally designed in terms of heat transfer coefficient, while at the same time affording the simple possibility of opening one or more of the cable bushings 19a, 19b, 19c, 19d as needed.

The window 9 shown in FIGS. 2 and 3 is suited to both installation in a new construction, where it is installed in an as yet unoccupied window opening, and to retrofitting in an already existing construction, where an already existing window is to be removed from the window opening. For this, the pivot frame needs to be dismounted and the anchored frame removed from the soffit and then the frame 11 of the new window 9 is installed.

If such major work on the masonry is not desirable in the case of a retrofitting, one can use a window 9 as described herein with the embodiment shown in FIG. 4. FIG. 4 shows once again the masonry 6, where a window is already installed in the window opening. This comprises a frame 21 as well as a swivel wing, already dismounted here. That is, the frame 21 is not removed, but instead remains anchored in the masonry 6. The frame 11 of the window 9 has hinge elements 22, which sit on hinge elements 23 of the already existing frame 21. The frame 11 will be anchored in this place. However, to prevent the entire window 9 pivoting with frame 11 and swivel wing 14, the frame 11 comprises a locking means 24, such as a pivoting bolt, which can be moved by a key from a release position, in which it lies in the frame 11, to a locking position, in which it protrudes from the frame 11 to the side and engages with a corresponding bolt pocket on the frame 21. This produces a locking of the frame 11 in this place, which can also be locked and then released once more, as described.

Otherwise, the window 9 is designed here the same as described above. In the example shown, once again it has four cable bushings 19a, 19b, 19c, 19d, which once again are closed for example with corresponding closure elements 20a, 20b, 20c, 20d at the factory and can be opened as needed. Alternatively, it is also possible to leave the cable bushings 19a, 19b, 19c, 19d open at the factory.

Some embodiments make possible the creation of a possibility for simple leading of any given conduit from the inside of a building to the outside with no major intrusion in its framework. Such a conduit may be an electrical cable, which runs to a charging station outside the house and runs by the shortest possible route from a household connection or circuit box to the outside through the window described herein. The window described herein can be used both in new and existing construction. By providing multiple cable bushings, the possibility also exists of leading multiple cables to the outside, and the cable bushings can also differ in cross sectional area and/or cross sectional shape, in order to lead cables of different thickness or shape in the best possible manner. Some embodiments also allow a simple replacement of a cable already led through a window as described herein by another possibly stronger or weaker cable, as well as simplifying the retrofitted laying of further cables through it, for example when a further charging station is to be connected afterwards, possibly charging with a higher power. The basic functionality of the window remains naturally assured in all forms of application.

German patent application no. 10 2021 131526.3, filed Dec. 1, 2021, to which this application claims priority, is hereby incorporated herein by reference in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A window, comprising:
a frame; and
a pivot frame arranged in the frame and hinge mounted on the frame, having a window pane,
wherein, at least one cable bushing to receive at least one cable is provided in the frame extending from one frame side to the opposite frame side.

2. The window according to claim 1, wherein, multiple cable bushings are provided.

3. The window according to claim 2, wherein, the multiple cable bushings have different cross sectional areas and/or different cross sectional shapes.

4. The window according to claim 1, wherein, the cable bushing is closed with a removable closure element.

5. The window according to claim 4, wherein, the closure element is designed such that its heat transfer coefficient corresponds substantially to the heat transfer coefficient of the frame.

6. The window according to claim 1, wherein, the frame is outfitted for direct mounting in a soffit of a masonry.

7. The window according to claim 1, wherein, the frame has at least two hinge elements on one frame side and on the other frame side it has at least one locking element, the hinge elements being adapted to connect with hinge elements of an existing frame on the masonry side and the locking element for locking to the frame on the masonry side.

8. A system, comprising:
masonry having a window opening;
a window installed in the window opening;
wherein the window includes a frame and a pivot frame arranged in the frame and hinge mounted on the frame, the pivot frame having a window pane, wherein, at least one cable bushing to receive at least one cable is provided in the frame extending from one frame side to the opposite frame side;
wherein a cable is led from one side of the masonry to the other side of the masonry through the cable bushing.

9. The system according to claim 8, wherein, the frame of the window is installed directly in a soffit bordering on the window opening, or the frame of the window is installed in a base frame installed in the window opening and fastened to it.

10. The system according to claim 8, wherein, a closure closing the cable bushing is provided on or in the cable bushing through which the cable runs.

11. The system according to claim 10, wherein, the closure is chosen such that the heat transfer coefficient in the area of the closure corresponds substantially to the heat transfer coefficient of the frame.

12. The system according to claim 10, wherein, the closure serves as a tension relief for the cable.

13. A charging layout for charging of an energy accumulator of a motor vehicle comprising:
a charging device situated outside a building for removable connecting to a charging terminal of the motor vehicle,
at least one cable running from the inside of the building to the charging device, and
a system according to claim 9, provided at the building side.
